(19) United States
(12) Patent Application Publication
(10) Pub. No.: US 2024/0383409 A1
(43) Pub. Date: Nov. 21, 2024

(54) FRONT TRUNK

(71) Applicant: TOYOTA BOSHOKU KABUSHIKI KAISHA, Aichi-ken (JP)

(72) Inventors: Kai AIZAWA, Toyota-shi (JP); Masahiro NAGANO, Toyota-shi (JP); Mitsutaka SAKOH, Nagakute-shi (JP)

(73) Assignee: TOYOTA BOSHOKU KABUSHIKI KAISHA, Aichi-ken (JP)

(21) Appl. No.: 18/650,371

(22) Filed: Apr. 30, 2024

(30) Foreign Application Priority Data
May 19, 2023 (JP) 2023-082898

(51) Int. Cl. B60R 5/02; B60R 13/01

(52) U.S. Cl. CPC B60R 5/02; B60R 13/011

(57) ABSTRACT

A front trunk includes a trunk box that opens toward one side and has a storing space therein and is disposed adjacent to a heat generator, and a metal layer disposed on at least a portion of an outer surface of the trunk box.

### CROSS REFERENCE TO RELATED APPLICATION

This application claims priority from Japanese Patent Application No. 2023-82898 filed on May 19, 2023. The entire contents of the priority application are incorporated herein by reference.

### TECHNICAL FIELD

The present technology described herein relates to a front trunk of a vehicle.

### BACKGROUND

In a mid-engine car including a driving system such as an engine in a middle section of a vehicular body and a rear-engine car including an engine in a rear section of a vehicular body, a storing space (a front trunk, which is a so-called frunk) can be provided in a front section of the vehicular body. Electric vehicles in which no engine is installed have been developed and such electric vehicles include front trunks. A frunk module (a trunk box) that is configured as a main body to form a storing space of the front trunk is firmly fixed to a vehicular body and such a mounting structure can absorb shock caused by a collision.

### SUMMARY

The trunk box, which is configured as a main body of the front trunk, has a box shape and is arranged in a front section of the vehicular body. Air is likely to flow near the front section when the vehicle is running. Therefore, condensation may be caused on the front box or the front box may be frozen. The front trunk is arranged in front of a vehicular compartment and defined separately from the vehicular compartment. Therefore, warm air in the vehicular compartment does not flow to the front trunk and the condensation on the front box and freezing of the front box are less likely to be prevented by the warm air in the vehicular compartment.

An object of the present technology described herein is to provide a front trunk that is less likely to cause condensation on and freezing of a trunk box.

To solve the above problems, a front trunk according to the technology described herein includes a trunk box that opens toward one side and has a storing space therein and is disposed adjacent to a heat generator and a metal layer disposed on at least a portion of an outer surface of the trunk box.

### BRIEF DESCRIPTION OF THE DRAWINGS

FIG. 1 is a perspective view of a vehicle including a front trunk according to one embodiment.

FIG. 2 is a perspective view of a trunk box of the front trunk.

FIG. 3 is a cross-sectional view of a portion of the trunk box.

FIG. 4 is a developed view of the trunk box seen from an outer surface side.

FIG. 5 is a graph representing sound reduction effect for trunk boxes having different surface coverage ratios.

FIG. 6 is a perspective view of a vehicle illustrating airflow near a body of a vehicle that does not include the front trunk of the embodiment.

FIG. 7 is a perspective view of a vehicle illustrating airflow near a body of a vehicle that includes the front trunk of the embodiment.

FIG. 8 is a developed view of a trunk box according to a modification seen from an outer surface side.

### DETAILED DESCRIPTION

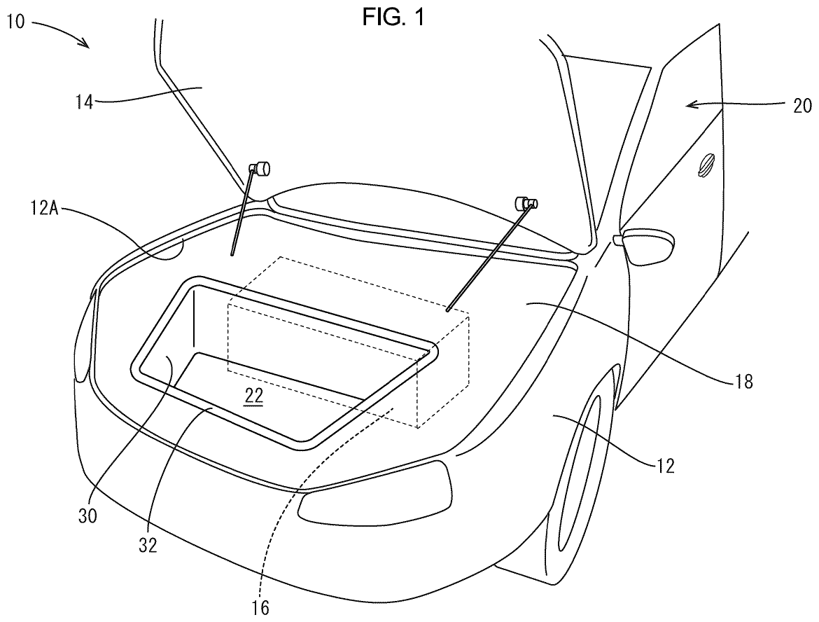

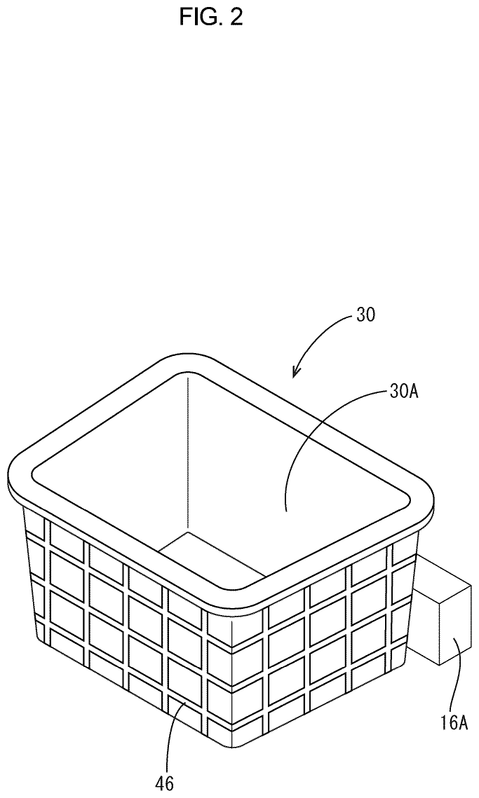

A vehicle 10 including a front trunk 22 according to one embodiment will be described with reference to FIGS. 1 to 7. As illustrated in FIG. 1, the vehicle 10 includes a vehicular body 12. The vehicular body 12 includes a front space 12A in a front section of the vehicular body 12 and the front space 12A opens upward. The vehicle 10 includes a bonnet 14 that is movable to close and open the front space 12A. The vehicle 10 is an electric car and no engine is installed in the vehicle 10. As illustrated in FIG. 2, a motor 16A is installed in the vehicle 10 as a driving power source. The vehicle 10 includes a driving unit 16 that includes the motor 16A. The driving unit 16 is installed in the front space 12A below the bonnet 14. The driving unit 16 is covered with a cover 18 from an upper side.

The front space 12A is large enough for receiving the driving unit 16 and a front trunk 22, which may be referred to as the frunk 22. The frunk 22 is arranged in front of a vehicular compartment 20 and defined separately from the vehicular compartment 20. Objects can be stored in the frunk 22.

The frunk 22 includes a front trunk box 30, which may be referred to as the frunk box 30, as a main body. As illustrated in FIG. 2, the front trunk box 30 is a box member. The frunk box 30 is a cuboid that opens upward. The frunk box 30 includes a bottom wall 30B, side surfaces including a rear wall 30A, side walls 30C, 30D, and a front wall 30E. The frunk box 30 is disposed in front of the driving unit 16 within the front space 12A. Seals 32 are attached to upper edges of the side walls of the frunk box 30. With the bonnet 14 being closed, a back surface of the bonnet 14 is contacted with the seals 32 and the frunk box 30 is sealed. The frunk box 30 and the bonnet 14 are configured as the frunk 22 having a sealed storing space therein. As illustrated in FIG. 2, with the frunk box 30 being arranged in the front space 12A, the motor 16A of the driving unit 16 is disposed adjacent to a lower edge portion of the rear wall 30A of the frunk box 30. The rear wall 30A is opposite the motor 16A.

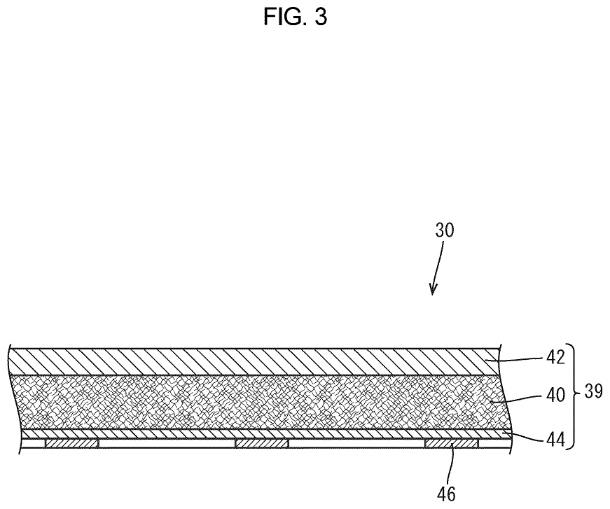

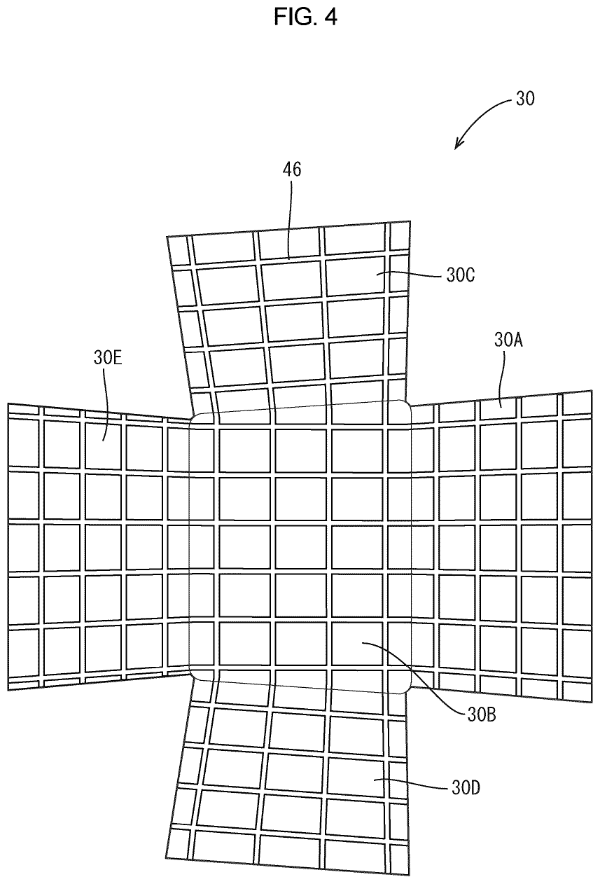

As illustrated in FIG. 3, the frunk box 30 includes a body member 39 and a metal layer 46. The body member 39 includes a base 40, a skin 42, and a protection layer 44 that are disposed on top of each other. The base 40 is made of synthetic resin fiber. The skin 42 is bonded to an entire area of an inner surface (a storing space side surface) of the base 40. The protection layer 44 is disposed on an entire area of a back surface (an outer surface) of the base 40. The metal layer 46 is disposed on an outer surface of the protection layer 44 of the body member 39. The metal layer 46 is preferably a thin metal film having high tensile rigidity and discharge characteristics. In this embodiment, the metal layer 46 is an aluminum metal film having a thickness of 2 mm or smaller. A thick metal layer increases weight of the vehicle. Therefore, the metal layer 46 is preferably thin and may have a thickness of 0.2 mm or smaller. As illustrated in FIG. 4, the metal layer 46 is formed in a grid pattern on an entire area of the outer surface (the back surface) of the frunk box 30. The metal layer 46 is formed on outer surfaces of the bottom wall 30B, the rear wall 30A, the side walls 30B, 30C, and the front wall 30E. As illustrated in FIGS. 2 and 4, most areas of the outer surfaces of the bottom wall 30B, the rear wall 30A, the side walls 30B, 30C, and the front wall 30E are not covered with the metal layer 46 and are exposed to the outside. In the most areas of the outer surfaces of the frunk box 30, the protection layer 44 is exposed to the outside.

The protection layer 44 is configured as a sound absorbing member and thermal insulation member. In this embodiment, the protection layer 44 is made of compressed non-woven fabric. The protection layer 44 needs rigidity and the weight per unit of the protection layer 44 is from 600 gsm to 4000 gsm. In this embodiment, the frunk box 30 includes the protection layer 44 separately on the outer surface of the base 40; however, the protection layer 44 may be integrally formed with the base 40. Namely, the compressed non-woven fabric that is same material as that of the protection layer 44 is formed in a shape of the frunk box 30 with increasing the weight per unit of the compressed non-fabric fabric and thus, the frunk box 30 is obtained. The base may have a multi-layered structure that includes two resin layers and non-woven fabric sandwiched between the two resin layers.

The frunk box 30 according to this embodiment is formed as described below. The skin 42, the base 40, and the protection layer 44 are disposed on top of each other and a plate member (pre-board) of the body member 39 is obtained. A metal film is formed in a grid pattern on the protection layer 44 with printing, painting, or vapor deposition. Then, the preboard including the metal film is press-molded into a box shape. Thus, the frunk box 30 is obtained. After the preboard is press-molded into a box shape, a metal tape such as an aluminum film may be bonded to the box-shaped molded member with adhesive material and thus, the metal layer 46 may be formed.

Next, the effects of the front trunk 22 having the above configuration will be described. Air flows into the front space 12A when the vehicle 10 is running. The air flowing near the frunk box 30 of the frunk 22 lowers the temperature of the outer surface of the frunk box 30. If temperature or humidity of air inside the frunk 22 is high, condensation may be caused on the inner surface of the frunk 22 or the inner surface of the frunk 22 may be frozen. In this embodiment, the frunk box 30 is disposed adjacent to the motor 16A and includes the metal layer 46 on the outermost surface of the frunk box 30. Heat is generated by the motor 16A while the vehicle 10 is running and the motor 16A is configured as a heat generator. Therefore, the metal layer 46 is warmed by radiant heat from the motor 16A while the vehicle 10 is running. More in detail, the portion of the metal layer 46 that is adjacent to the motor 16A is warmed by the radiant heat from the motor 16A. The lower portion of the rear wall 30A and the rear portion of a bottom wall 30B are warmed by the heat from the metal layer 46. The metal layer 46 is formed in a grid pattern on the entire area of the back surface (the outer surface) of the frunk box 30. As illustrated in FIG. 4, the metal layer 46 is formed in entire areas of the rear wall 30A, the bottom wall 30B, the side walls 30C, 30D, and the front wall 30E. Therefore, the heat from the motor 16A is transferred to the bottom wall 30B, the side walls 30C, 30D, and the front wall 30E from the rear wall 30A. Thus, all the surfaces of the frunk box 30 can be warmed. According to the frunk 22, a whole outer surface of the frunk box 30 can be warmed and condensation or freezing can be effectively suppressed. Since the frunk 22 is defined separately from the vehicular compartment 20, warm air in the vehicular compartment 20 does not flow to the frunk 22; however, the frunk 22 is warmed by radiant heat from the motor 16A that is disposed adjacent to the frunk box 30. Therefore, condensation or freezing is less likely to be caused.

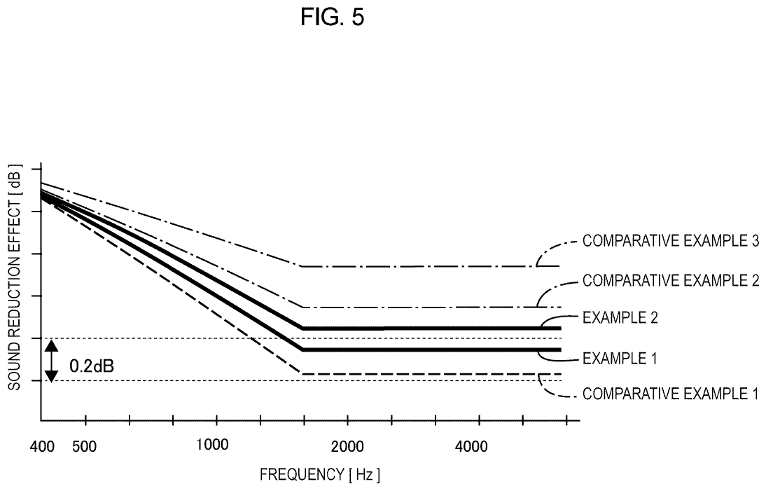

The frunk box 30 can absorb noise, which is caused while the vehicle is running, with the protection layer 44. However, as the area occupied by the metal layer 46 on the outer surface of the frunk box 30 increases, the noise absorbing ability is lowered. A ratio of the surface area of the portions of the outer surface of the funk box 30 where the metal layer 46 is formed to the surface area of the entire outer surface of the frunk box 30 is defined as a surface coverage ratio. Frunk boxes are prepared with the surface coverage ratio being changed, the sound reduction effects of the frunk boxes with respect to the frequencies of noise or vibration were calculated theoretically based on the sound absorption coefficient. The calculation results are illustrated in FIG. 5. In FIG. 5, as the value (dB) represented by the vertical axis is smaller, the noise reduction effects are higher. Specifically, the graphs in FIG. 5 represent the results of Examples 1 and 2, and Comparative Examples 1, 2, and 3. In Comparative Example 1, the surface overage ratio of the metal layer 46 is 0% and no metal layer is disposed. The surface cover ratio is 30% in Comparative Example 2 and 50% in Comparative Example 3. The surface coverage ratio of the metal layer 46 is 10% in Example 1 and 20% in Example 2. As is obvious from the graphs in FIG. 5, as the surface cover ratio increases, the noise reduction effect is reduced compared to the Comparative Example 1 that includes no metal layer.

As illustrated in FIG. 5, the noise reduction effect of Examples 1 and 2 in which the surface coverage ratio is 10% and 20% differs from that of Comparative Example 1 by 0.2 dB or smaller. Examples 1 and 2 can obtain the noise reduction effect that is similar to that of Comparative Example 1. Therefore, the surface coverage ratio is preferably 10% or greater and 20% or smaller. The frunk box 30 of this embodiment includes the metal layer 46 that is formed in a grid pattern. With such a configuration, the metal layer 46 is formed in a grid pattern on an entire area of the outer surface of the frunk box 30 such that the surface coverage ratio of the metal layer 46 is slightly greater than 10%. According to this embodiment, condensation is less likely to be caused on the frunk box 30 and the frunk box 30 is less likely to be frozen with suppressing lowering of the sound absorbing ability.

In the frunk 22, with the ratio of the surface area of the metal layer 46 to the entire surface area of the frunk box 30 being 20% or less than 20%, the lowering of sound absorbing effect can be surely suppressed. A certain ratio of the surface area of the metal layer 46 to the entire surface area is necessary to effectively absorb heat from the heat generator and suppress condensation and freezing, and the ratio is preferably 10% or greater.

In the frunk 22 of this embodiment, the metal layer 46 is formed on a large area of the outer surface of the frunk box 30 with suppressing lowering of the sound absorbing effect. Therefore, a large area of the frunk box 30 can be warmed with keeping good sound absorbing effect. Furthermore, in the frunk 22 of this embodiment, rigidity of the frunk box 30 can be increased. Particularly, the rigidity with respect to the direction of tension can be increased.

Furthermore, since the frunk box 30 of the front trunk 22 includes the metal layer 46, electric charge on the body panel (the bonnet 14) is reduced. This stabilizes the air flow around the running vehicle 10 and running ability can be increased.

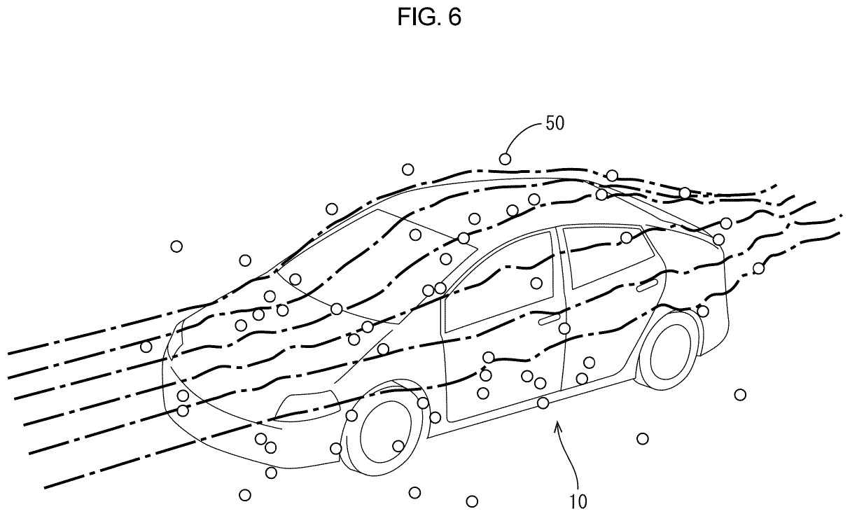

The air that flows around the running vehicle may be charged negative or positive. As illustrated in FIG. 6, the amount of negative ions 50 or positive ions 50 may be increased around the vehicle 10. The body panel may be negatively charged or positively charged by static electricity caused when the vehicle 10 is running. If the body panel and the air around the body panel are charged with the same polarity during the vehicle's running, repulsion is likely to be caused between the surface of the body panel and the air. With the repulsion being caused between the surface of the body panel and the air, turbulent airflow such as air flow separation from the surface of the body panel may occur in the air flowing near the surface of the body panel as illustrated in FIG. 6. Due to the air flow separation caused during the vehicle's running, desired aerodynamic characteristic may not be obtained and running stability or running performance may be lowered.

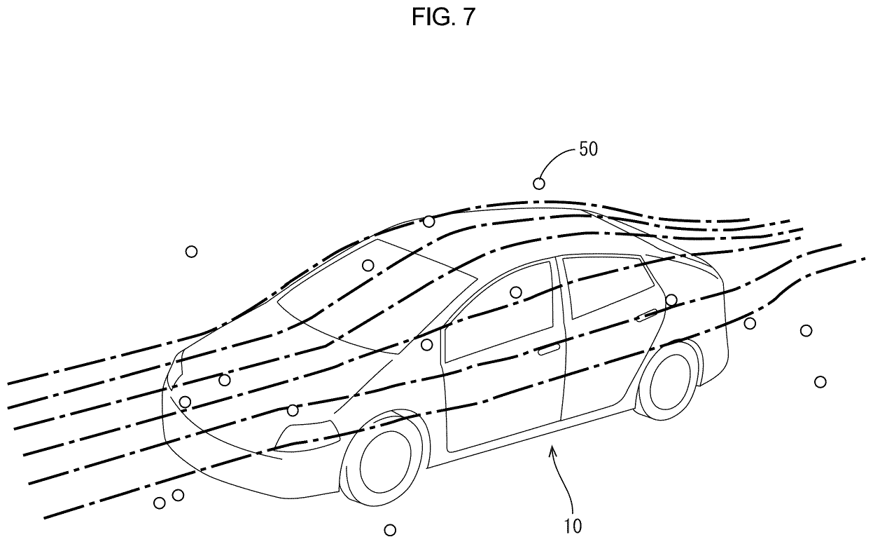

In this embodiment, the metal layer 46 of the frunk box 30 can temporally store the electric charges of the bonnet 14. With the bonnet 14 being closed, the bonnet 14 is electrically connected to the metal layer 46 of the frunk box 30 via the rear surface of the bonnet 14. With such a configuration, the frunk box 30 can store the negative charge or the positive charges of the bonnet 14. The electric charge is likely to be concentrated on edge portions of the metal layer 46 and self-discharge (corona discharge) is caused. The minus ions or plus ions that are generated by the self-discharge attract ions having a different polarity and are neutralized. Therefore, electric charge on the bonnet 14 can be reduced. As illustrated in FIG. 7, the air flow during the vehicle's running can be stabilized and running ability can be increased. In FIG. 7, the airflow is illustrated with the roof panel, the doors and other members being configured to store electric charge.

In the front trunk 22, the metal layer 46 of the frunk box 30 can absorb radiant heat from the motor 16A or a beat pump and the frunk box 30 is warmed. Accordingly, condensation and freezing are less likely to be caused. The operation efficiency of the motor 16A changes according to the temperature change and the appropriate temperature around the motor 16A is desired. In the front trunk 22 of this embodiment, with the frunk box 30 that is adjacent to the motor 16A being warmed, the temperature around the motor 16A is less likely to drop. Thus, the appropriate temperature around the motor 16A can be maintained and the operation efficiency of the motor 16A is less likely to be decreased.

In the front trunk 22, the area and the portions of the frunk box 30 where the metal layer 46 is formed are not particularly specified; however, the metal layer 46 is preferably formed on at least the portion of the frunk box 30 that is adjacent to the heat generator because the metal layer 46 is warmed by the radiant heat from the heat generator. As the area where the metal layer 46 is formed increases, the sound absorbing ability of the front trunk 22 is decreased. Therefore, to maintain good sound absorbing ability, the metal layer 46 may not be formed to extend over an entire area of the outer surface of the frunk box 30 but may be preferably formed on a portion of the outer surface of the frunk box 30. Material of the metal layer 46 is not particularly limited to any special material but may preferably have good thermal conductivity.

### <Modifications>

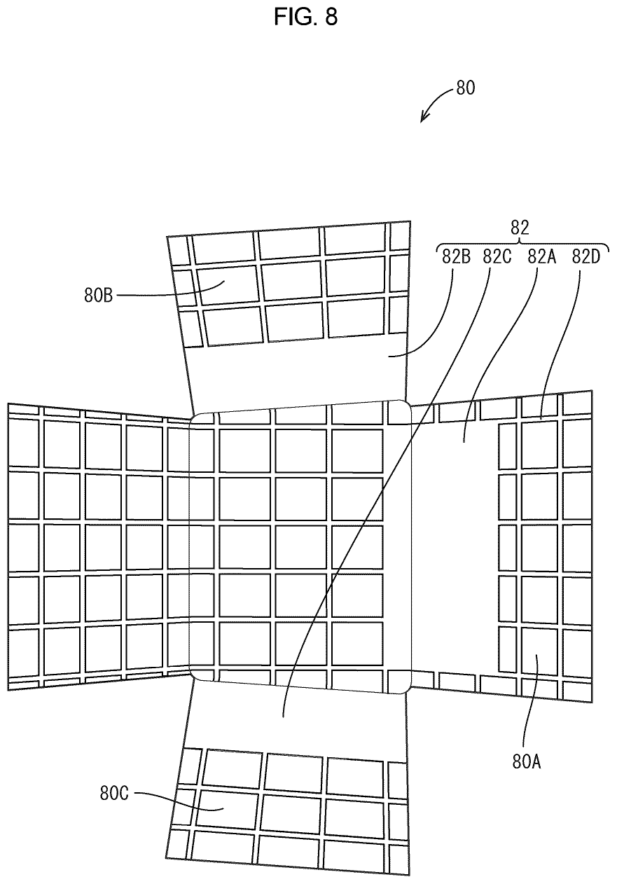

In the front trunk 22 of the above embodiment, the metal layer 46 is formed in a grid pattern on an entire area of the outer surface of the frunk box 30; however, the metal layer may be formed in a different pattern and in a different area as long as the metal layer is formed on at least a portion of the frunk box. The metal layer may be preferably formed on a portion of the frunk box such that the heat transferred from the heat generator can be transferred to a whole funk box. For example, as illustrated in FIG. 8, a metal layer 82 may be formed on a frunk box 80. As illustrated in FIG. 8, the metal layer 82 includes a first metal portion 82A, a second metal portion 82B, a third metal portion 82C, a fourth metal portion 82D. The first metal portion 82A is on a lower portion of a rear wall 80A of the frunk box 80 that is opposite the motor 16A. The first metal portion 82A is opposite the motor 16A. The first metal portion 82A is not formed in a grid pattern but in a solid pattern on the outer surface of the lower portion of the rear wall 80A. The first metal portion 82A extends in a planar area of the lower portion of the rear wall 80A. The second metal portion 82B and the third metal portion 82C are on lower portions of side walls 80B, 80C. While the vehicle is running, the amount of airflow near the lower portions of the side walls 80B. 80C is large and the lower portions of the side walls 80B, 80C are likely to be cooled. The second metal portion 82B and the third metal portion 82C are formed in a solid pattern on the outer surface of the lower portions of the side walls 80B, 80C. The second metal portion 82B and the third metal portion 82C extend in planar areas of the lower portions of the side walls 80B, 80C. The fourth metal portion 82D is formed in a grid pattern on upper portions of the rear wall 80A and the side walls 80B, 80C, and front and bottom surfaces of the frunk box 80. The first metal portion 82A, the second metal portion 82B, and the third metal portion 82C are connected to each other via the fourth metal portion 82D.

In the frunk box 80, with the metal layer 82 being formed in the pattern described above, the first metal portion 82A has a large planar area that is opposite the motor 16A and can absorb a large amount of radiant heat from the motor 16A. The fourth metal portion 82D extends from the first metal portion 82A so as to be away from the motor 16A and is configured as an extending portion. With such a configuration, the heat is effectively transferred from the first metal portion 82A to the second metal portion 82B, the third metal portion 82C, and the fourth metal portion 82D. Furthermore, the second metal portion 82B and the third metal portion 82C having large planar areas are formed on the side walls 80B, 80C that are likely to be cooled. The second metal portion 82B and the third metal portion 82C that extend in planar areas and have large areas can receive a large amount of heat from the first metal portion 82A and warm the side walls 80B, 80C effectively. According to the frunk box 80, the first metal portion 82A having a large area can effectively absorb heat from the motor 16A and the absorbed heat can be transferred to the portions of the frunk box 80 far away from the motor 16A via the fourth metal portion 82D. Furthermore, lowering of the temperature around the motor 16A is effectively suppressed and the operation efficiency of the motor 16A is less likely to be lowered. Furthermore, with the second metal portion 82B and the third metal portion 82C being formed in a solid pattern on a planar surface area, the inner surface portions corresponding to the second metal portion 82B and the third metal portion 82C are less likely to be cooled and condensation and freezing are less likely to be caused.

In this embodiment, the metal layer 82 absorbs radiant beat, however, heat retention effect of the protection layer 44, which is made of compressed non-woven fiber, is higher than heat retention effect of the metal layer 82. Therefore, the areas of the first metal portion 82A, the second metal portion 82B, and the third metal portion 82C, which extend in planar areas, are defined in appropriate ranges based on the results of temperature simulation such that the metal portions 82A, 82B, 82C are not cooled too much by the airflow. Accordingly, the heat retention effect near the motor 16A and the heat retention effect of the inner portions corresponding to the second metal portion 82B and the third metal portion 82C can be maintained and appropriate temperature of the vicinity of the motor 16A and the frunk box 30 can be maintained.

### OTHER EMBODIMENTS

The technology described herein is not limited to the embodiments described above with reference to the drawings. The technology described herein may be modified within the technical scope. The following embodiments may be included in the technical scope.

The metal layer is preferably formed in a smaller area to suppress the lowering of sound absorbing effect Therefore, the metal layer may not be formed on portions of the frunk box where condensation and freezing are less likely to be caused.

The heat generator that warms the metal layer 46 may not be the driving motor 16A. In the vehicle that includes a heat pump for warming the vehicular compartment 20, the heat pump may be used as the heat generator for warming the metal layer 46.

In the present embodiments, the vehicle 10 is an electric car that includes the front trunk 22; however, the vehicle is not necessarily limited to such an electric car. For example, the vehicle may be a mid-engine car including an engine in a middle section of a vehicular body and a rear-engine car including an engine in a rear section of a vehicular body and front trunks of such vehicles may have the configuration of the technology described herein.

1. A front trunk comprising:
a trunk box that opens toward one side and has a storing space therein and is disposed adjacent to a heat generator; and
a metal layer disposed on at least a portion of an outer surface of the trunk box.

2. The front trunk according to claim 1, wherein the metal layer is formed in a grid pattern.

3. The front trunk according to claim 2, wherein the metal layer is on an entire area of the outer surface.

4. The front trunk according to claim 1, wherein the metal layer includes a first metal portion that is opposite the heat generator and an extending portion that extends from the first metal portion so as to be away from the heat generator.

5. The front trunk according to claim 1, wherein a surface coverage ratio of an area of the metal layer to an entire area of the outer surface of the trunk box is 10% or greater and 20% or smaller.

6. The front trunk according to claim 1, wherein the trunk box includes a base and a protection layer and the metal layer is disposed on the protection layer.

7. The front trunk according to claim 6, wherein the protection layer is made of compressed non-woven fabric.

8. The front trunk according to claim 1, wherein
the trunk box includes a bottom wall and side walls extending from edges of the bottom wall, and
the metal layer is disposed on outer surfaces of the bottom wall and the side walls.

9. The front trunk according to claim 8, wherein
the metal layer includes a first metal portion that extends in a planar area of one of the bottom wall and the side walls that is opposite the heat generator, and
the metal layer includes extending portions that extend from the first metal portion to other ones of the bottom wall and the side walls that are not opposite the heat generator.
